(19) United States
(12) Patent Application Publication
(10) Pub. No.: US 2006/0264314 A1
(43) Pub. Date: Nov. 23, 2006

(54) Group of alpha-sialon compositions and a method for the production thereof

(75) Inventor: Saeid Esmaeilzadeh, Stockholm (SE)

Correspondence Address: CONNOLLY BOVE LODGE & HUTZ LLP, SUITE 800, 1990 M STREET NW, WASHINGTON, DC, 20036-3425, US

(73) Assignee: Diamorph Ceramic AB, Stockholm (SE)

(21) Appl. No.: 11/078,616

(22) Filed: Mar. 14, 2005

(51) Int. Cl. C04B 35/599

(52) U.S. Cl. 501/98.2

(57) ABSTRACT

The invention relates to a new group of nitrogen rich α-sialon compositions with the general formula MₓSi₁₂₍ₘ₊ₙ₎Al₍ₘ₊ₙ₎OₙN₁₆₋ₙ, where x (=m/v)≦2, v is the average valency of the M cation, and the ratio m/(m+n)≧0.7. The new compositions obtained by this method have one of the following elements M, or combinations thereof, in the cavity of the α-sialon structure: Li, Na, Mg, Ca, Sr, Ba, Sc, Y, La, Ce, Pr, Nd, Sm, Eu, Gd, Tb, Dy, Ho, Er, Tm, Yb, Th, Pa or U.

### FIELD OF THE INVENTION

The invention relates to new α-sialon compositions and a method for producing the compositions. The α-sialons have high nitrogen content and have been found to have good mechanical properties such as hardness and fracture toughness.

### BACKGROUND OF THE INVENTION

Si₃N₄ and SiAlON based materials have been intensively investigated during the last decades due to their superior mechanical properties with good thermal stability and excellent thermo-shock properties. These properties have a wide range of applications and used such as ceramic cutting tools, ceramic bearings, ceramic substrate, space industry, and continues to receive attention in the automotive component market. As compared with carbide-based materials, or steel materials, silicon nitride generally offers the potential of relatively high heat resistance and chemical stability, relatively low density, good mechanical properties such as hardness and toughness, and good electrical insulation characteristics. To illustrate the advantages, in the context of the cutting tool industry, these properties can combine in whole or in part to allow operations to proceed at higher speeds and temperatures, with resulting potential cost savings. The potential market for the above properties indicates use in other applications, such as, extrusion dies and automotive components, turbocharger components, swirl chambers, and engine valve.

Single-phase of Si₃N₄ is a high covalent compound and exist in 2 hexagonal polymorphic crystalline forms α- and β-Si₃N₄, β-Si₃N₄ being more stable than the a form. The structure of α- and β-Si₃N₄ is build up from basic SiN₄ tetrahedral joined in three-dimensional network by sharing corners, with common nitrogen to the three tetrahedral sites. Either structure can be generated from the other by a 180° rotation of 2 basal planes. The α- to β-Si₃N₄ transition is usually by a solution-precipitation reaction of Si₃N₄ and molten glass. The strong covalent bonds of Si₃N₄ give these materials properties such as low thermal expansion coefficient, good thermal shock resistance, high strength, high toughness, greater Young's modulus than some metals, thermal stability up to 1800° C., which is the temperature when Si₃N₄ starts to decompose. The weak point of this material is difficulties of self-diffusion and production of Si₃N₄ into a dense body by classical method of ceramic processing technology. This problem can be helped to a large extent by using sintering additives, glass-formers and also by formation of sialons by substituting silicon and nitrogen with aluminium and oxygen.

Nitrogen rich sialon phases have been extensively studied in connection with the development of high performance ceramics, especially in α- and β-sialon systems [T. Ekström and M. Nygren, J.Am. Ceram. Soc., 75, 259 (1992)]. The structure of α-Si₃N₄ was established using single crystal X-ray diffraction (XRD) data and film methods [R. Marchand et al, Acta Cryst. B25, 2157 (1969)] and more accurate atomic positions were obtained in later single crystal XRD studies [I. Kohatsu et al, Mat. Res. Bul., 9, 917 (1974) and K. Kato et al., J. Am. Ceram. Soc., 58, 90 (1975)]. Structural changes of α-Si₃N₄ with temperature, below 900 C have also been investigated using neutron powder diffraction data [M. Billy et al., Mat. Res. Bul., 18, 921 (1983)]. The α-Si₃N₄ crystallises in the space group P31c with the unit cell parameters a=7.7523(2), c=5.6198(2) Å, V=292.5 Å³ [Powder Diffraction File 41-0360, International Centre for Diffraction Data, Newtown Square, Pa.] and unit cell content Si₁₂N₁₆.

The α-sialons are solid solutions that have a filled α-Si₃N₄ type structure. There are two substitution mechanisms. First, silicon and nitrogen can be substituted simultaneously by aluminium and oxygen. Second, the structure has two large, closed cavities per unit cell that can accommodate additional cations of metals, M=Li, Mg, Ca, Y, and Rare Earth (RE) elements. A general formula for α-sialons can thus be written as MₓSi₁₂₍ₘ₊ₙ₎Al₍ₘ₊ₙ₎OₙN₁₆₋ₙ, where x (=m/v)≦2, and v is the average valency of the M cation. For all of the known o-sialon compositions the m/(m+n) ratio is found to be below 0.67. Examples of reported α-sialon phases are Y.5 (Si9.75 Al2.25) (N15.25O0.75) and Ca.67 (Si10 Al2) (N15.3 O0.7) [ F. Izumi et al., Journal of Materials Science, 19, 3115 (1984)]. The synthesis approach that is usually used includes metal oxides or carbonates of M=Li, Mg, Ca, Y, and RE as additives used either as substitution in α-sialon crystal structure or as glass-formers and sintering additives.

In an article from Journal of the American Ceramic Society 86 (4) 727-30, 2003 “Structures of filled α-Si3N4-Type Ca0.27La0.03Al0.62N16 and LiSi9Al3O2N14” is described how the single crystals of Ca0.27 La0.03 Al0.62N16 were observed after a preparation of lanthanum nitridosilicates in a graphite furnace containing calcium residues.

In the Swedish patent application 0300056-9 is described a method for obtaining nitrogen rich glasses by using non oxide additives. The mechanical properties of the nitrogen rich glass phases have been reported to be improved with increased nitrogen content.

Even though α-sialon phases have been used in many different commercial applications, specially as single phase ceramics or together with other compounds in composite ceramics, and despite an intensive scientific investigations and developments in this field there has been crucial limitations in the chemical compositions of the crystalline α-sialon phases as well as in the intergranular glassy phase found in the ceramic bodies produced.

### SUMMARY OF THE INVENTION

The invention presents new nitrogen rich α-sialon compositions and a new synthesis method for synthesis of α-sialon and α-sialon based ceramics.

The α-sialon compositions can be described by the formula MₓSi]₂₋₍ₘ₊ₙ₎Al₍ₘ₊ₙ₎OₙN₁₆₋ₙ, where x (=m/v)≦2, and v is the average valency of the M cation. The new compositions obtained by this method have one of the following elements exclusively, or combinations of those, in the cavity of the α-sialon structure, M=Li, Na, Mg, Ca, Sr, Ba, Sc, Y, Ce, Pr, Nd, Sm, Eu, Gd, Th, Dy, Ho, Er, Tm, Yb, Th, Pa or U. At the same time the ratio of m/(m+n) must be higher than 0.7.

The method includes synthesis at temperatures generally in the range 1500-1800° C. in nitrogen atmosphere using nitrides and oxides of silicon and aluminium in combination with additives such as Li, Na, Mg, Ca, Sr, Ba, Sc, Y, La, Ce, Pr, Nd, Sm, Eu, Gd, Tb, Dy, Ho, Er, Tm, Yb, Th, Pa or U. The additives are used as non oxide precursors such as pure metal, nitrides e.g. Ca₃N₂, LaN, YN, hydrides e.g. CaH₂, MgH₂, or other sources that transforms to nitrides or metallic state in nitrogen atmosphere at elevated temperatures used during the synthesis. The above mentioned metals can also be added as oxides or carbonates if used together with graphite in nitrogen atmosphere in order to form the metal nitride through a carbothermal reduction. These unique processes provide a possibility to incorporate additives in synthesis α-sialon without simultaneous incorporation of oxygen atoms. The materials obtained by this process have been found to posses good mechanical properties such as high Vickers hardness values, typically above 20.0 Gpa and fracture toughness values typically above 5.0 MPa.m^{1/2}. One of the most important aspects of this invention is that new α-sialon compositions that can be obtained were the aluminium content in the crystalline phase is fully or partially balanced by addition of the stabilising metals rather than the exchange of nitrogen by oxygen.

This new synthesis route provides a tool for preparation of α-sialon based ceramics with high nitrogen content as well as higher amounts of additives incorporated into the system.

An α-sialon based ceramic material can encompass other phases, such as beta-sialon.

For the sintering process the liquid phase is important as well as the solidified liquid which forms an intergranular glass phase. According to an embodiment of the invention the glass phase can be formed with significantly higher nitrogen content. This is possible since the precursors used in the synthesis as additives are non oxide materials, or a mixture of precursors which transforms to a nitride during the synthesis in nitrogen atmosphere, and therefore allows much higher nitrogen incorporation. The metal nitrides that are formed are very reactive and act as glass modifiers.

The synthesis processes according to an embodiment of the invention allows for production of highly densified α-sialon based ceramics. The densification is promoted by higher concentrations of additives. The additives are important components in the process of forming the liquid phase, which is essential for the recrystallisation of the sialon phase. The densification can be obtained by using a hot pressing synthesis, a gas-pressure synthesis or synthesis at ambient pressure.

The synthesis processes according to an embodiment of the invention allows for preparation of α-sialon ceramics with mono-dispersed and elongated crystallites. The sialon crystals are obtained through a re-crystallisation process. The initial components are dissolved in the liquid phase and recrystallised as sialon crystallites. The liquid acts as a nitrogen rich flux and to some extent as one of the nitrogen sources for the crystalline phases.

The α-sialon materials can be used as powder samples, sintered ceramic bodies or thin films in different applications such as ceramic cutting tools, ceramic ball bearings, ceramic gas turbins, ceramic body implants, wear resistant ceramics, magneto-optical applications, substrates for electronics and luminescent materials.

The α-sialon thin films can be a ceramic layer of a body of ceramic sialon or any other material that is usually covered with thin films. The thin film can have a thickness in the range of 10 nano-meters to 1.0 mm.

### BRIEF DESCRIPTION OF THE DRAWINGS

FIG. 1 is an example of a Hot Pressing schedule for SiAlON samples.

### DESCRIPTION OF THE PREFERRED EMBODIMENTS

The invention relates to a new group of nitrogen rich α-sialon compositions with the general formula MₓSi₁₂₍ₘ₊ₙ₎Al₍ₘ₊ₙ₎OₙN₆₋ₙ, where x (=m/v)≦2, v is the average valency of the M cation, and the ratio m/(m+n)≦0.7.

Preferably 0.35≧x (=m/v)≧2, and in particularly preferred compositions, the ratio m/(m+n) is respectively greater than 0.75, 0.8, 0.85, 0.9 or 0.95.

The new compositions obtained by this method have one of the following elements M exclusively, or combinations thereof, in the cavity of the α-sialon structure: Li, Na, Mg, Ca, Sr, Ba, Sc, Y, La, Ce, Pr, Nd, Sm, Eu, Gd, Th, Dy, Ho, Er, Tm, Yb, Th, Pa, U or combinations thereof.

The new α-sialon phases obtained are found to possess larger unit cell parameters than for previously reported α-sialon phases. The reason for this is the high nitrogen content in combination with high concentrations of M cations in the cavity of the structure of α-sialon. The α-axis are found to be larger than 7.84 Å for most of the phases and α-parameters higher than 7.86 Å, 7.88 Å, 7.90 Å, 7.92 Å and even 7.94 Å were observed. The c-axis was found to be larger than 5.72 Å for most of the phases and c-parameters larger than 5.73 Å, 5.74 Å, 5.75 Å and even 5.76 Å were observed. The cell volumes of the obtained α-sialon phases were found to increase with the increasing content of the M cation and the nitrogen concentration. The cell volumes were found to be larger than 305.0 Å³ for most of the phases and cell volumes larger than 307.0 Å³, 309.0 Å³, 311.0 Å³ and even 313.0 Å³ were observed.

In a second aspect, the present invention relates to a method for preparing such α-sialon phases using non oxide precursors for incorporating M cations such as M=Li, Na, Mg, Ca, Sr, Ba, Sc, Y, La, Ce, Pr, Nd, Sm, Eu, Gd, Th, Dy, Ho, Er, Tm, Yb, Th, Pa or U. The precursors used can be as metals, nitrides, e.g. Mg₃N₂, Ca₃N₂, YN, SmN, hydrides, e.g. MgH₂, CaH₂, SrH₂, YH₃, SmH₃ or other precursors that are transformed to nitrides during the synthesis in nitrogen atmosphere. Another possible synthesis route is to use oxides or carbonates of the above mentioned M cations together with graphite powder in nitrogen atmosphere in order to convert the oxides or carbonates in to nitrides through carbothermal reduction. An example of such synthesis process is described below:
6CaCO₃+3C+2N₂ [symbol] 2Ca₃N₂+9CO₂.

The above described precursors for introduction of the M cation are mixed together with fine powders of nitrides and oxides of silicon and aluminium before heat treatment. The synthesis can be performed at a temperature of 1500-1800° C., during 30 minutes to 12 hours depending on the synthesis volumes and chemical compositions.

### EXAMPLES

Synthesis Procedures Used for the Below Mentioned Examples:

The α-sialon phases were obtained either as pure phases or together with other crystalline and amorphous phases by using pressureless synthesis in a graphite furnace, radio frequency induction furnace or a hot pressing synthesis using a uni-axial pressure of 32 Mpa. The synthesis atmosphere used was nitrogen independent of the furnace used. The precursors used in every specific synthesis were carefuly ground and pressed to pellets, before placing in the furnace. In those cases were nitrides, hydrides or pure metals of additives such as Mg, Ca, Sr, Y or rare earths were used, contacts with air was avoided in order to avoid oxidation of those precursors.

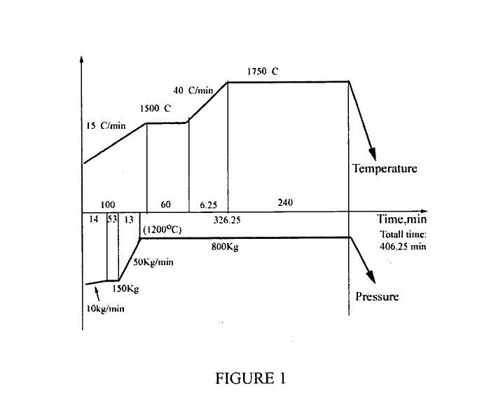

The hot-pressed samples were prepared under a uni-axial pressure of 32 Mpa at 1750° C. during 4 hours in flowing nitrogen atmosphere, using the raising schedule of FIG. 1. The samples synthesised in the graphite furnace or the radio frequency furnace were prepared at 1750° C. during 4 hours in flowing nitrogen atmosphere, using ambient gas pressure.

Examples of α-sialon compositions with a ratio of m/(m+n) higher than 0.7. The hot pressing preparation method of FIG. 1 has been applied to the following examples.

| Sam- | | | | | |
|---|---|---|---|---|---|
| ple # | M | SiN_{4/3} | AlN | AlO_{1.5} | Alpha phase composition |
| 1 | CaH₂ 0.2 | 11.6 | 0.4 | — | Ca_{0.2}Si_{11.6}Al_{0.4}N₁₆ |
| 2 | CaH₂ 0.4 | 11.2 | 0.8 | — | Ca_{0.4}Si_{11.2}AN₁₆ |
| 3 | CaH₂ 0.6 | 10.8 | 1.2 | — | Ca_{0.6}Si_{10.8}Al_{1.2}N₁₆ |
| 4 | CaH₂ 0.8 | 10.4 | 1.6 | — | Ca_{0.8}Si_{10.4}Al_{1.6}N₁₆ |
| 5 | CaH₂ 1.0 | 10.0 | 2.0 | — | Ca_{1.0}Si_{10.0}Al_{2.0}N₁₆ |
| 6 | CaH₂ 1.2 | 9.6 | 2.4 | — | Ca_{1.2}Si_{9.6}Al_{2.4}N₁₆ |
| 7 | CaH₂ 1.4 | 9.2 | 2.8 | — | Ca_{1.4}Si_{9.2}Al_{2.8}N₁₆ |
| 8 | CaH₂ 1.6 | 8.8 | 3.2 | — | Ca_{1.6}Si_{8.8}Al_{3.2}N₁₆ |
| 9 | CaH₂ 1.8 | 8.4 | 3.6 | — | Ca_{1.8}Si_{8.4}Al_{3.6}N₁₆ |
| 10 | CaH₂ 2.0 | 8.0 | 4.0 | — | Ca_{2.0}Si_{8.0}Al_{4.0}N₁₆ |
| 11 | CaH₂ 0.6 | 10.3 | 1.2 | 0.5 | Ca_{0.6}Si_{10.3}Al_{1.7}O_{0.5}N_{15.5} |
| 12 | CaH₂ 0.8 | 9.9 | 1.6 | 0.5 | Ca_{0.8}Si_{9.9}Al_{2.1}O_{0.5}N_{15.5} |
| 13 | CaH₂ 1.0 | 9.5 | 2.0 | 0.5 | Ca_{1.0}Si_{9.5}Al_{2.5}O_{0.5}N_{15.5} |
| 14 | CaH₂ 1.2 | 9.1 | 2.4 | 0.5 | Ca_{1.2}Si_{9.1}Al_{2.9}O_{0.5}N_{15.5} |
| 15 | CaH₂ 1.4 | 8.7 | 2.8 | 0.5 | Ca_{1.4}Si_{8.7}Al_{3.3}O_{0.5}N_{15.5} |
| 16 | CaH₂ 1.6 | 8.3 | 3.2 | 0.5 | Ca_{1.6}Si_{8.3}Al_{3.7}O_{0.5}N_{15.5} |
| 17 | CaH₂ 1.8 | 7.9 | 3.6 | 0.5 | Ca_{1.8}Si_{7.9}Al_{4.1}O_{0.5}N_{15.5} |
| 18 | CaH₂ 2.0 | 7.5 | 4.0 | 0.5 | Ca_{2.0}Si_{7.5}Al_{4.5}O_{0.5}N_{15.5} |
| 19 | CaH₂ 1.2 | 8.6 | 2.4 | 1.0 | Ca_{1.2}Si_{8.6}Al_{3.4}O₁N₁₅ |
| 20 | CaH₂ 1.4 | 8.2 | 2.8 | 1.0 | Ca_{1.4}Si_{8.2}Al_{3.8}O₁N₁₅ |
| 21 | CaH₂ 1.6 | 7.8 | 3.2 | 1.0 | Ca_{1.6}Si_{7.8}Al_{4.2}O₁N₁₅ |
| 22 | CaH₂ 1.8 | 7.4 | 3.6 | 1.0 | Ca_{1.8}Si_{7.4}Al_{4.6}O₁N₁₅ |
| 23 | CaH₂ 2.0 | 7.0 | 4.0 | 1.0 | Ca_{2.0}Si_{7.0}Al_{5.0}O₁N₁₅ |
| 24 | CaH₂ 1.8 | 6.9 | 3.6 | 1.5 | Ca_{1.8}Si_{6.9}Al_{5.1}O_{1.5}N_{14.5} |
| 25 | CaH₂ 2.0 | 6.5 | 4.0 | 1.5 | Ca_{2.0}Si_{6.5}Al_{5.5}O_{1.5}N_{14.5} |
| 26 | CaN_{2/3} 0.2 | 11.6 | 0.4 | — | Ca_{0.2}Si_{11.6}Al_{0.4}N₁₆ |
| 27 | CaN_{2/3} 0.4 | 11.2 | 0.8 | — | Ca_{0.4}Si_{11.2}Al_{0.8}N₁₆ |
| 28 | CaN_{2/3} 0.6 | 10.8 | 1.2 | — | Ca_{0.6}Si_{10.8}Al_{1.2}N₁₆ |
| 29 | CaN_{2/3} 0.8 | 10.4 | 1.6 | — | Ca_{0.8}Si_{10.4}Al_{1.6}N₁₆ |
| 30 | CaN_{2/3} 1.0 | 10.0 | 2.0 | — | Ca_{1.0}Si_{10.0}Al_{2.0}N₁₆ |
| 31 | CaN_{2/3} 1.2 | 9.6 | 2.4 | — | Ca_{1.2}Si_{9.6}Al_{2.4}N₁₆ |
| 32 | CaN_{2/3} 1.4 | 9.2 | 2.8 | — | Ca_{1.4}Si_{9.2}Al_{2.8}N₁₆ |
| 33 | CaN_{2/3} 1.6 | 8.8 | 3.2 | — | Ca_{1.6}Si_{8.8}Al_{3.2}N₁₆ |
| 34 | CaN_{2/3} 1.8 | 8.4 | 3.6 | — | Ca_{1.8}Si_{8.4}Al_{3.6}N₁₆ |
| 35 | CaN_{2/3} 2.0 | 8.0 | 4.0 | — | Ca_{2.0}Si_{8.0}Al_{4.0}N₁₆ |
| 36 | CaN_{2/3} 0.6 | 10.3 | 1.2 | 0.5 | Ca_{0.6}Si_{10.3}Al_{1.7}O_{0.5}N_{15.5} |
| 37 | CaN_{2/3} 0.8 | 9.9 | 1.6 | 0.5 | Ca_{0.8}Si_{9.9}Al_{2.1}O_{0.5}N_{15.5} |
| 38 | CaN_{2/3} 1.0 | 9.5 | 2.0 | 0.5 | Ca_{1.0}Si_{9.5}Al_{2.5}O_{0.5}N_{15.5} |
| 39 | CaN_{2/3} 1.2 | 9.1 | 2.4 | 0.5 | Ca_{1.2}Si_{9.1}Al_{2.9}O_{0.5}N_{15.5} |
| 40 | CaN_{2/3} 1.4 | 8.7 | 2.8 | 0.5 | Ca_{1.4}Si_{8.7}Al_{3.3}O_{0.5}N_{15.5} |
| 41 | CaN_{2/3} 1.6 | 8.3 | 3.2 | 0.5 | Ca_{1.6}Si_{8.3}Al_{3.7}O_{0.5}N_{15.5} |
| 42 | CaN_{2/3} 1.8 | 7.9 | 3.6 | 0.5 | Ca_{1.8}Si_{7.9}Al_{4.1}O_{0.5}N_{15.5} |
| 43 | CaN_{2/3} 2.0 | 7.5 | 4.0 | 0.5 | Ca_{2.0}Si_{7.5}Al_{4.5}O_{0.5}N_{15.5} |
| 44 | CaN_{2/3} 1.2 | 8.6 | 2.4 | 1.0 | Ca_{1.2}Si_{8.6}Al_{3.4}O₁N₁₅ |
| 45 | CaN_{2/3} 1.4 | 8.2 | 2.8 | 1.0 | Ca_{1.4}Si_{8.2}Al_{3.8}O₁N₁₅ |
| 46 | CaN_{2/3} 1.6 | 7.8 | 3.2 | 1.0 | Ca_{1.6}Si_{7.8}Al_{4.2}O₁N₁₅ |
| 47 | CaN_{2/3} 1.8 | 7.4 | 3.6 | 1.0 | Ca_{1.8}Si_{7.4}Al_{4.6}O₁N₁₅ |
| 48 | CaN_{2/3} 2.0 | 7.0 | 4.0 | 1.0 | Ca_{2.0}Si_{7.0}Al_{5.0}O₁N₁₅ |
| 49 | CaN_{2/3} 1.8 | 6.9 | 3.6 | 1.5 | Ca_{1.8}Si_{6.9}Al_{5.1}O_{1.5}N_{14.5} |
| 50 | CaN_{2/3} 2.0 | 6.5 | 4.0 | 1.5 | Ca_{2.0}Si_{6.5}Al_{5.5}O_{1.5}N_{14.5} |

Examples of α-sialon compositions with a ratio of m/(m+n) higher than 0.7. The owing samples have been prepared in a conventional graphite furnace.

| Sample # | M | SiN_{4/3} | AlN | AlO_{1.5} | Alpha phase composition |
|---|---|---|---|---|---|
| 51 | (CaCO₃ + C) 0.2 | 11.6 | 0.4 | — | Ca_{0.2}Si_{11.6}Al_{0.4}N₁₆ |
| 52 | (CaCO₃ + C) 0.4 | 11.2 | 0.8 | — | Ca_{0.4}Si_{11.2}Al_{0.8}N₁₆ |
| 53 | (CaCO₃ + C) 0.6 | 10.8 | 1.2 | — | Ca_{0.6}Si_{10.8}Al_{1.2}N₁₆ |
| 54 | (CaCO₃ + C) 0.8 | 10.4 | 1.6 | — | Ca_{0.8}Si_{10.4}Al_{1.6}N₁₆ |
| 55 | (CaCO₃ + C) 1.0 | 10.0 | 2.0 | — | Ca_{1.0}Si_{10.0}Al_{2.0}N₁₆ |
| 56 | (CaCO₃ + C) 1.2 | 9.6 | 2.4 | — | Ca_{1.2}Si_{9.6}Al_{2.4}N₁₆ |
| 57 | (CaCO₃ + C) 1.4 | 9.2 | 2.8 | — | Ca_{1.4}Si_{9.2}Al_{2.8}N₁₆ |
| 58 | (CaCO₃ + C) 1.6 | 8.8 | 3.2 | — | Ca_{1.6}Si_{8.8}Al_{3.2}N₁₆ |
| 59 | (CaCO₃ + C) 1.8 | 8.4 | 3.6 | — | Ca_{1.8}Si_{8.4}Al_{3.6}N₁₆ |
| 60 | (CaCO₃ + C) 2.0 | 8.0 | 4.0 | — | Ca_{2.0}Si_{8.0}Al_{4.0}N₁₆ |
| 61 | (CaCO₃ + C) 0.6 | 10.3 | 1.2 | 0.5 | Ca_{0.6}Si_{10.3}Al_{1.7}O_{0.5}N_{15.5} |
| 62 | (CaCO₃ + C) 0.8 | 9.9 | 1.6 | 0.5 | Ca_{0.8}Si_{9.9}Al_{2.1}O_{0.5}N_{15.5} |
| 63 | (CaCO₃ + C) 1.0 | 9.5 | 2.0 | 0.5 | Ca_{1.0}Si_{9.5}Al_{2.5}O_{0.5}N_{15.5} |
| 64 | (CaCO₃ + C) 1.2 | 9.1 | 2.4 | 0.5 | Ca_{1.2}Si_{9.1}Al_{2.9}O_{0.5}N_{15.5} |
| 65 | (CaCO₃ + C) 1.4 | 8.7 | 2.8 | 0.5 | Ca_{1.4}Si_{8.7}Al_{3.3}O_{0.5}N_{15.5} |
| 66 | (CaCO₃ + C) 1.6 | 8.3 | 3.2 | 0.5 | Ca_{1.6}Si_{8.3}Al_{3.7}O_{0.5}N_{15.5} |
| 67 | (CaCO₃ + C) 1.8 | 7.9 | 3.6 | 0.5 | Ca_{1.8}Si_{7.9}Al_{4.1}O_{0.5}N_{15.5} |
| 68 | (CaCO₃ + C) 2.0 | 7.5 | 4.0 | 0.5 | Ca_{2.0}Si_{7.5}Al_{4.5}O_{0.5}N_{15.5} |
| 69 | (CaCO₃ + C) 1.2 | 8.6 | 2.4 | 1.0 | Ca_{1.2}Si_{8.6}Al_{3.4}O₁N₁₅ |
| 70 | (CaCO₃ + C) 1.4 | 8.2 | 2.8 | 1.0 | Ca_{1.4}Si_{8.2}Al_{3.8}O₁N₁₅ |
| 71 | (CaCO₃ + C) 1.6 | 7.8 | 3.2 | 1.0 | Ca_{1.6}Si_{7.8}Al_{4.2}O₁N₁₅ |
| 72 | (CaCO₃ + C) 1.8 | 7.4 | 3.6 | 1.0 | Ca_{1.8}Si_{7.4}Al_{4.6}O₁N₁₅ |
| 73 | (CaCO₃ + C) 2.0 | 7.0 | 4.0 | 1.0 | Ca_{2.0}Si_{7.0}Al_{5.0}O₁N₁₅ |
| 74 | (CaCO₃ + C) 1.8 | 6.9 | 3.6 | 1.5 | Ca_{1.8}Si_{6.9}Al_{5.1}O_{1.5}N_{14.5} |
| 75 | (CaCO₃ + C) 2.0 | 6.5 | 4.0 | 1.5 | Ca_{2.0}Si_{6.5}Al_{5.5}O_{1.5}N_{14.5} |
| 76 | Mg 0.2 | 11.6 | 0.4 | — | Mg_{0.2}Si_{11.6}Al_{0.4}N₁₆ |
| 77 | Mg 0.4 | 11.2 | 0.8 | — | Mg_{0.4}Si_{11.2}Al_{0.8}N₁₆ |
| 78 | Mg 0.6 | 10.8 | 1.2 | — | Mg_{0.6}Si_{10.8}Al_{1.2}N₁₆ |
| 79 | Mg 0.8 | 10.4 | 1.6 | — | Mg_{0.8}Si_{10.4}Al_{1.6}N₁₆ |
| 80 | Mg 1.0 | 10.0 | 2.0 | — | Mg_{1.0}Si_{10.0}Al_{2.0}N₁₆ |
| 81 | Mg 1.2 | 9.6 | 2.4 | — | Mg_{1.2}Si_{9.6}Al_{2.4}N₁₆ |
| 82 | Mg 1.4 | 9.2 | 2.8 | — | Mg_{1.4}Si_{9.2}Al_{2.8}N₁₆ |
| 83 | Mg 1.6 | 8.8 | 3.2 | — | Mg_{1.6}Si_{8.8}Al_{3.2}N₁₆ |
| 84 | Mg 1.8 | 8.4 | 3.6 | — | Mg_{1.8}Si_{8.4}Al_{3.6}N₁₆ |
| 85 | Mg 2.0 | 8.0 | 4.0 | — | Mg_{2.0}Si_{8.0}Al_{4.0}N₁₆ |
| 86 | Mg 0.6 | 10.3 | 1.2 | 0.5 | Mg_{0.6}Si_{10.3}Al_{1.7}O_{0.5}N_{15.5} |
| 87 | Mg 0.8 | 9.9 | 1.6 | 0.5 | Mg_{0.8}Si_{9.9}Al_{2.1}O_{0.5}N_{15.5} |
| 88 | Mg 1.0 | 9.5 | 2.0 | 0.5 | Mg_{1.0}Si_{9.5}Al_{2.5}O_{0.5}N_{15.5} |
| 89 | Mg 1.2 | 9.1 | 2.4 | 0.5 | Mg_{1.2}Si_{9.1}Al_{2.9}O_{0.5}N_{15.5} |
| 90 | Mg 1.4 | 8.7 | 2.8 | 0.5 | Mg_{1.4}Si_{8.7}Al_{3.3}O_{0.5}N_{15.5} |
| 91 | Mg 1.6 | 8.3 | 3.2 | 0.5 | Mg_{1.6}Si_{8.3}Al_{3.7}O_{0.5}N_{15.5} |
| 92 | Mg 1.8 | 7.9 | 3.6 | 0.5 | Mg_{1.8}Si_{7.9}Al_{4.1}O_{0.5}N_{15.5} |
| 93 | Mg 2.0 | 7.5 | 4.0 | 0.5 | Mg_{2.0}Si_{7.5}Al_{4.5}O_{0.5}N_{15.5} |
| 94 | Mg 1.2 | 8.6 | 2.4 | 1.0 | Mg_{1.2}Si_{8.6}Al_{3.4}O₁N₁₅ |
| 95 | Mg 1.4 | 8.2 | 2.8 | 1.0 | Mg_{1.4}Si_{8.2}Al_{3.8}O₁N₁₅ |
| 96 | Mg 1.6 | 7.8 | 3.2 | 1.0 | Mg_{1.6}Si_{7.8}Al_{4.2}O₁N₁₅ |
| 97 | Mg 1.8 | 7.4 | 3.6 | 1.0 | Mg_{1.8}Si_{7.4}Al_{4.6}O₁N₁₅ |
| 98 | Mg 2.0 | 7.0 | 4.0 | 1.0 | Mg_{2.0}Si_{7.0}Al_{5.0}O₁N₁₅ |
| 99 | Mg 1.8 | 6.9 | 3.6 | 1.5 | Mg_{1.8}Si_{6.9}Al_{5.1}O_{1.5}N_{14.5} |
| 100 | Mg 2.0 | 6.5 | 4.0 | 1.5 | Mg_{2.0}Si_{6.5}Al_{5.5}O_{1.5}N_{14.5} |
| 101 | (YO_{1.5} + 1.5C) 1.0 | 9.0 | 3.0 | — | Y_{1.0}Si_{9.0}Al_{3.0}N₁₆ |
| 102 | (YO_{1.5} + 1.5C) 1.6 | 7.2 | 4.8 | — | Y_{1.6}Si_{7.2}Al_{4.8}N₁₆ |
| 103 | (YO_{1.5} + 1.5C) 2.0 | 6.0 | 6.0 | — | Y_{2.0}Si_{6.0}Al_{6.0}N₁₆ |
| 104 | (YO_{1.5} + 1.5C) 1.0 | 8.5 | 3.0 | 0.5 | Y_{1.0}Si_{8.5}Al_{3.5}O_{0.5}N_{15.5} |
| 105 | (YO_{1.5} + 1.5C) 2.0 | 5.5 | 6.0 | 0.5 | Y_{2.0}Si_{5.5}Al_{6.5}O_{0.5}N_{15.5} |
| 106 | (YO_{1.5} + 1.5C) 1.8 | 5.6 | 5.4 | 1.0 | Y_{1.8}Si_{5.6}Al_{6.4}O₁N₁₅ |
| 107 | (YO_{1.5} + 1.5C) 2.0 | 4.5 | 6.0 | 1.5 | Y_{2.0}Si_{4.5}Al_{7.5}O_{1.5}N_{14.5} |
| 108 | La 1.0 | 9.0 | 3.0 | — | La_{1.0}Si_{9.0}Al_{3.0}N₁₆ |
| 109 | La 1.6 | 7.2 | 4.8 | — | La_{1.6}Si_{7.2}Al_{4.8}N₁₆ |
| 110 | La 2.0 | 6.0 | 6.0 | — | La_{2.0}Si_{6.0}Al_{6.0}N₁₆ |
| 111 | La 1.0 | 8.5 | 3.0 | 0.5 | La_{1.0}Si_{8.5}Al_{3.5}O_{0.5}N_{15.5} |
| 112 | La 2.0 | 5.5 | 6.0 | 0.5 | La_{2.0}Si_{5.5}Al_{6.5}O_{0.5}N_{15.5} |
| 113 | La 1.8 | 5.6 | 5.4 | 1.0 | La_{1.8}Si_{5.6}Al_{6.4}O₁N₁₅ |
| 114 | La 2.0 | 4.5 | 6.0 | 1.5 | La_{2.0}Si_{4.5}Al_{7.5}O_{1.5}N_{14.5} |
| 115 | Pr 1.0 | 9.0 | 3.0 | — | Pr_{1.0}Si_{9.0}Al_{3.0}N₁₆ |
| 116 | Pr 1.6 | 7.2 | 4.8 | — | Pr_{1.6}Si_{7.2}Al_{4.8}N₁₆ |
| 117 | Pr 2.0 | 6.0 | 6.0 | — | Pr_{2.0}Si_{6.0}Al_{6.0}N₁₆ |
| 118 | Pr 1.0 | 8.5 | 3.0 | 0.5 | Pr_{1.0}Si_{8.5}Al_{3.5}O_{0.5}N_{15.5} |
| 119 | Pr 2.0 | 5.5 | 6.0 | 0.5 | Pr_{2.0}Si_{5.5}Al_{6.5}O_{0.5}N_{15.5} |
| 120 | Pr 1.8 | 5.6 | 5.4 | 1.0 | Pr_{1.8}Si_{5.6}Al_{6.4}O₁N₁₅ |
| 121 | Pr 2.0 | 4.5 | 6.0 | 1.5 | Pr_{2.0}Si_{4.5}Al_{7.5}O_{1.5}N_{14.5} |
| 122 | Yb 1.0 | 9.0 | 3.0 | — | Yb_{1.0}Si_{9.0}Al_{3.0}N₁₆ |
| 123 | Yb 1.6 | 7.2 | 4.8 | — | Yb_{1.6}Si_{7.2}Al_{4.8}N₁₆ |
| 124 | Yb 2.0 | 6.0 | 6.0 | — | Yb_{2.0}Si_{6.0}Al_{6.0}N₁₆ |
| 125 | Yb 1.0 | 8.5 | 3.0 | 0.5 | Yb_{1.0}Si_{8.5}Al_{3.5}O_{0.5}N_{15.5} |
| 126 | Yb 2.0 | 5.5 | 6.0 | 0.5 | Yb_{2.0}Si_{5.5}Al_{6.5}O_{0.5}N_{15.5} |
| 127 | Yb 1.8 | 5.6 | 5.4 | 1.0 | Yb_{1.8}Si_{5.6}Al_{6.4}O₁N₁₅ |
| 128 | Yb 2.0 | 4.5 | 6.0 | 1.5 | Yb_{2.0}Si_{4.5}Al_{7.5}O_{1.5}N_{14.5} |
| 129 | Nd 1.0 | 9.0 | 3.0 | — | Nd_{1.0}Si_{9.0}Al_{3.0}N₁₆ |
| 130 | Nd 1.6 | 7.2 | 4.8 | — | Nd_{1.6}Si_{7.2}Al_{4.8}N₁₆ |
| 131 | Nd 2.0 | 6.0 | 6.0 | — | Nd_{2.0}Si_{6.0}Al_{6.0}N₁₆ |
| 132 | Nd 1.0 | 8.5 | 3.0 | 0.5 | Nd_{1.0}Si_{8.5}Al_{3.5}O_{0.5}N_{15.5} |
| 133 | Nd 2.0 | 5.5 | 6.0 | 0.5 | Nd_{2.0}Si_{5.5}Al_{6.5}O_{0.5}N_{15.5} |
| 134 | Nd 1.8 | 5.6 | 5.4 | 1.0 | Nd_{1.8}Si_{5.6}Al_{6.4}O₁N₁₅ |
| 135 | Nd 2.0 | 4.5 | 6.0 | 1.5 | Nd_{2.0}Si_{4.5}Al_{7.5}O_{1.5}N_{14.5} |

Mechanical properties of selected samples synthesised by hot-pressing are shown below. The hardness and fracture toughness of those samples have been obtained by using Vickers indentation technique.

| | AnstisEq. | Anstis Eq. | Evans Eq. | Evans Eq. |
|---|---|---|---|---|
| Sample | Hv10/Gpa | K1c/MPa · m ½ | Hv10/Gpa | K1c/MPa · m ½ |
| 1 | 20.5475 | 4.718524 | 15.07317 | 4.797079 |
| 2 | 22.3411 | 5.3631 | 21.0001 | 6.436 |
| 3 | 21.1437 | 5.3418 | 19.8751 | 6.2352 |
| 4 | 21.6825 | 5.7279 | 20.3815 | 6.7715 |
| 5 | 21.3531 | 5.7233 | 20.0719 | 6.7127 |
| 6 | 21.0242 | 5.5275 | 19.7628 | 6.4336 |
| 7 | 20.606 | 5.7539 | 19.3696 | 6.6307 |
| 8 | 20.9173 | 5.8811 | 19.6622 | 6.8286 |
| 9 | 20.0268 | 5.50003 | 18.8252 | 6.2491 |
| 10 | 20.0779 | 5.615 | 18.8732 | 6.3883 |

Unit cell parameters and unit cell volumes of some selected α-sialon samples.

| | | | Unit cell | |
|---|---|---|---|---|
| | a-parameter | c-parameter | volume | |
| Sample # | (Å) | (Å) | (Å³) | composition |
| 1 | 7.7717 | 5.639 | 294.96 | Ca_{0.2}Si_{11.6}Al_{0.4}N₁₆ |
| 2 | 7.7862 | 5.6512 | 296.7 | Ca_{0.4}Si_{11.2}Al_{0.8}N₁₆ |
| 3 | 7.806 | 5.6673 | 299.06 | Ca_{0.6}Si_{10.8}Al_{1.2}N₁₆ |
| 4 | 7.8242 | 5.6817 | 301.22 | Ca_{0.8}Si_{10.4}Al_{1.6}N₁₆ |
| 5 | 7.8434 | 5.697 | 303.52 | Ca_{1.0}Si_{10.0}Al_{2.0}N₁₆ |
| 6 | 7.866 | 5.7129 | 306.12 | Ca_{1.2}Si_{9.6}Al_{2.4}N₁₆ |
| 7 | 7.8853 | 5.7258 | 308.32 | Ca_{1.4}Si_{9.2}Al_{2.8}N₁₆ |
| 8 | 7.903 | 5.7378 | 310.36 | Ca_{1.6}Si_{8.8}Al_{3.2}N₁₆ |
| 9 | 7.9249 | 5.7514 | 312.82 | Ca_{1.8}Si_{8.4}Al_{3.6}N₁₆ |
| 10 | 7.9428 | 5.763 | 314.87 | Ca_{2.0}Si_{8.0}Al_{4.0}N₁₆ |

We claim:

1. An alpha-sialon material having formula MₓSi₁₂₋₍ₘ₊ₙ₎Al₍ₘ₊ₙ₎OₙN₁₆₋ₙ, where x (=m/v)≦2, and v is the average valency of a M cation and wherein the ratio m/(m+n) is higher than 0.7.

2. An alpha-sialon material according to claim 1, wherein 0.35≦x (=m/v)≦2.

3. An alpha-sialon material according to claim 1, wherein the ratio m/(m+n) is higher than 0.75.

4. An alpha-sialon material according to claim 1, wherein the ratio m/(m+n) is higher than 0.80.

5. An alpha-sialon material according to claim 1, wherein the ratio m/(m+n) is higher than 0.85.

6. An alpha-sialon material according to claim 1, wherein the ratio m/(m+n) is higher than 0.90.

7. An alpha-sialon material according to claim 1, wherein the ratio m/(m+n) is higher than 0.95.

8. An alpha-sialon material according to claim 1, wherein a crystallographic trigonal space group symmetry P31c and a unit cell volume is larger than 305.0 Å³.

9. An alpha-sialon material according to claim 1, wherein a crystallographic trigonal space group symmetry P31c and an a-axis of the unit cell is larger than 7.84 Å.

10. An alpha-sialon material according to claim 7, wherein a crystallographic trigonal space group symmetry P31c and an a-axis of the unit cell is larger than 7.84 Å.

11. An alpha-sialon material according to claim 1, wherein a crystallographic trigonal space group symmetry P31c and a c-axis of the unit cell is larger than 5.72 Å.

12. An alpha-sialon material according to claim 7, wherein a crystallographic trigonal space group symmetry P31c and a c-axis of the unit cell is larger than 5.72 Å.

13. An alpha-sialon material according to claim 9, wherein a crystallographic trigonal space group symmetry P31c and a c-axis of the unit cell is larger than 5.72 Å.

14. An alpha-sialon material according to claim 1, wherein M is one or more metal selected form the group consisting of Li, Na, Mg, Ca, Sr, Ba, Sc, Y, Ce, Pr, Nd, Sm, Eu, Gd, Tb, Dy, Ho, Er, Tm, Yb, Th, Pa or U.

15. An alpha-sialon material according to claim 13, wherein M is La.

16. An alpha-sialon material according to claim 13, wherein said alpha-sialon is formed from a powder mixture of nitrides and oxides of silicon and aluminum together with a further powder comprising one or more element from the group consisting of Li, Na, Mg, Ca, Sr, Ba, Sc, Y, La, Ce, Pr, Nd, Sm, Eu, Gd, Th, Dy, Ho, Er, Tm, Yb, Th, Pa or U, whereby said one or more element shall be in a metallic state or in form of a nitride or hydride or another form that is transformed into a nitride during a heat treating step between 1500-1800° C. in nitrogen gas atmosphere.

17. An alpha-sialon material according to claim 13, wherein said alpha-sialon is formed from a powder mixture of nitrides and oxides of silicon and aluminum together with a further powder comprising one or more element from the group consisting of Li, Na, Mg, Ca, Sr, Ba, Sc, Y, La, Ce, Pr, Nd, Sm, Eu, Gd, Th, Dy, Ho, Er, Tm, Yb, Th, Pa or U, whereby said one or more element shall be in the form of an oxide or carbonate, to which graphite powder is added order to convert said oxides or carbonates in to nitrides through carbothermal reduction in a heat treating step between 1500-1800° C. in nitrogen gas atmosphere.

18. An alpha-sialon material, wherein a crystallographic trigonal space group symmetry P31c and a unit cell volume is larger than 305.0 Å³.

19. An alpha-sialon material according to claim 18, wherein a crystallographic trigonal space group symmetry P31c and a unit cell volume is larger than 307.0 Å³.

20. An alpha-sialon material according to claim 18, wherein a crystallographic trigonal space group symmetry P31c and a unit cell volume is larger than 309.0 Å³.

21. An alpha-sialon material according to claim 18, wherein a crystallographic trigonal space group symmetry P31c and a unit cell volume is larger than 311.0 Å³.

22. An alpha-sialon material according to claim 18, wherein a crystallographic trigonal space group symmetry P31c and a unit cell volume is larger than 313.0 Å³.

23. An alpha-sialon material, wherein a crystallographic trigonal space group symmetry P31c and an a-axis of the unit cell is larger than 7.84 Å

24. An alpha-sialon material according to claim 23, wherein a crystallographic trigonal space group symmetry P31c and an a-axis of the unit cell is larger than 7.86 Å.

25. An alpha-sialon material according to claim 23, wherein a crystallographic trigonal space group symmetry P31c and an a-axis of the unit cell is larger than 7.88 Å.

26. An alpha-sialon material according to claim 23, wherein a crystallographic trigonal space group symmetry P31c and an a-axis of the unit cell is larger than 7.90 Å.

27. An alpha-sialon material according to claim 23, wherein a crystallographic trigonal space group symmetry P31c and an a-axis of the unit cell is larger than 7.92 Å.

28. An alpha-sialon material according to claim 23, wherein a crystallographic trigonal space group symmetry P31c and an a-axis of the unit cell is larger than 7.94 Å.

29. An alpha-sialon material, wherein a crystallographic trigonal space group symmetry P31c and a c-axis of the unit cell is larger than 5.72 Å.

30. An alpha-sialon material according to claim 29, wherein a crystallographic trigonal space group symmetry P31c and a c-axis of the unit cell is larger than 5.73 Å.

31. An alpha-sialon material according to claim 29, wherein a crystallographic trigonal space group symmetry P31c and a c-axis of the unit cell is larger than 5.74 Å.

32. An alpha-sialon material according to claim 29, wherein a crystallographic trigonal space group symmetry P31c and a c-axis of the unit cell is larger than 5.75 Å.

33. An alpha-sialon material according to claim 29, wherein a crystallographic trigonal space group symmetry P31c and a c-axis of the unit cell is larger than 5.76 Å.

34. A sintered ceramic body comprising an alpha-sialon material according to claim 1.

35. A sintered ceramic body comprising an alpha-sialon material according to claim 13.

36. A sintered ceramic body comprising an alpha-sialon material according to claim 18.

37. A sintered ceramic body comprising an alpha-sialon material according to claim 23.

38. A sintered ceramic body comprising an alpha-sialon material according to claim 29.

39. A sintered ceramic body in accordance with claim 34, wherein an intergranular phase comprises an amorphous phase with high nitrogen content being formed by non oxide precursors used in a synthesis in nitrogen atmosphere.

40. A body comprising a surface layer of an alpha-sialon material according to claim 1, said layer having a thickness in the range of 10 nanometers to 1.0 millimeter.

41. A method for making an alpha-sialon material, wherein synthesis of fine powders of nitrides and oxides of silicon and aluminium are mixed together with additives such as one or more element from the group of Li, Na, Mg, Ca, Sr, Ba, Sc, Y, La, Ce, Pr, Nd, Sm, Eu, Gd, Tb, Dy, Ho, Er, Tm, Yb, Th, Pa or U and said additives are in the form of pure metals, nitrides, hydrides or another form that transforms to nitrides or metallic state in nitrogen atmosphere at during a heat treatment step at temperatures in the range of 1500-1800° C.

42. A method for making an alpha-sialon material, wherein synthesis of fine powders of nitrides and oxides of silicon and aluminium are mixed together with additives such as one or more element from the group of Li, Na, Mg, Ca, Sr, Ba, Sc, Y, La, Ce, Pr, Nd, Sm, Eu, Gd, Th, Dy, Ho, Er, Tm, Yb, Th, Pa or U and said additives are in the form of oxides or carbonates and used together with graphite in nitrogen atmosphere in order to form a metal nitride through a carbothermal reduction.
